(19) United States
(12) Patent Application Publication
(10) Pub. No.: US 2007/0005524 A1
(43) Pub. Date: Jan. 4, 2007

(54) Connected online reactive advertising lite board

(76) Inventor: Walter N Iwachin, SUNNYSIDE, NY (US)

Correspondence Address: WALTER IWACHIW, 48-35 41ST ST., SUNNYSIDE, NY, 11104, US

(21) Appl. No.: 10/525,547

(22) PCT Filed: Feb. 13, 2005
(86) PCT No.: PCT/US05/05998

§ 371 Date: Feb. 13, 2005

(51) Int. Cl. G06N 3/02

(52) U.S. Cl. 706/15

(57) ABSTRACT

An advertising display kiosk device of various configurations in size and application that passively and proactively dispense advertising to target subjects in the immediate local environment of the display device. An apparatus, process and method for acquiring sensory information from the local environment and processing the information in a AI computer program to determine a likely match to a set of stored models. The AI selects ads or responses to the set of stored models. Relevant ads are matched by the AI Program for the purpose of displaying relevant informational ads, notifying emergency services, or connection to two way capable data streams via network connections. These devices can also act to connect to (PSTN) or other communication networks.

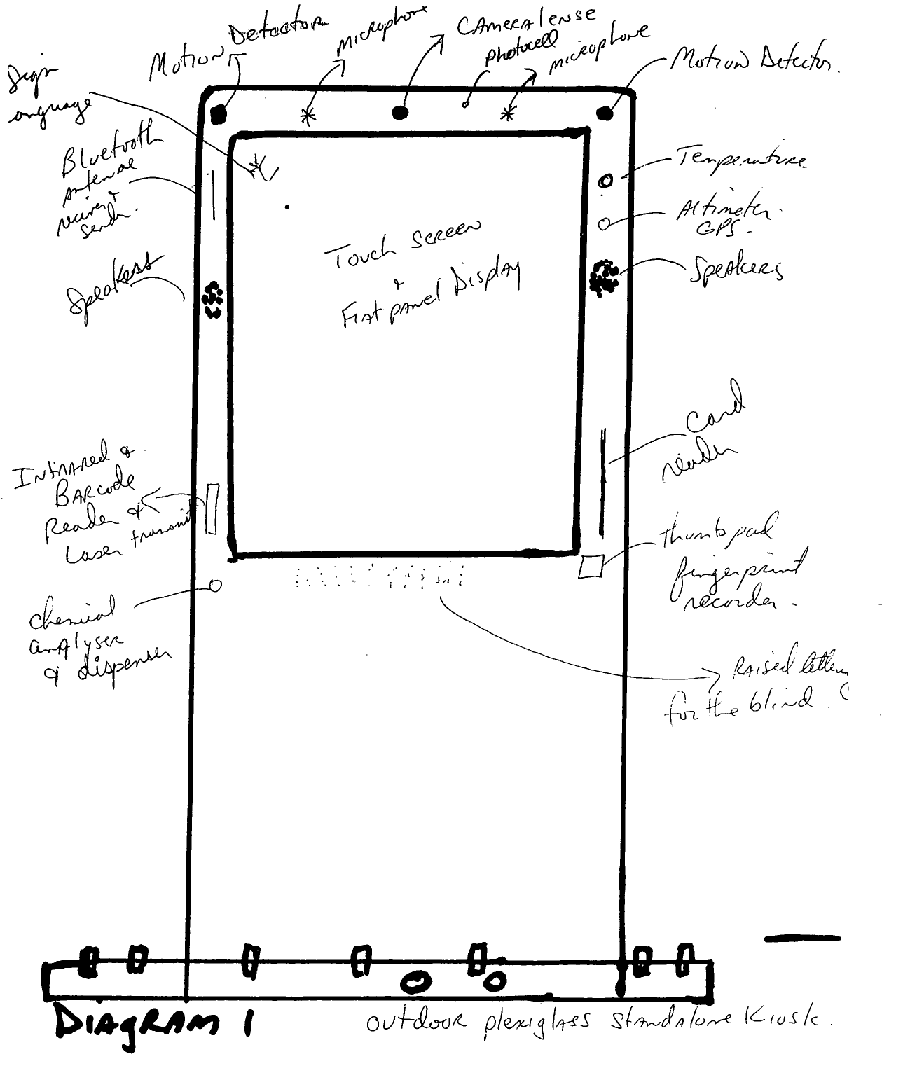

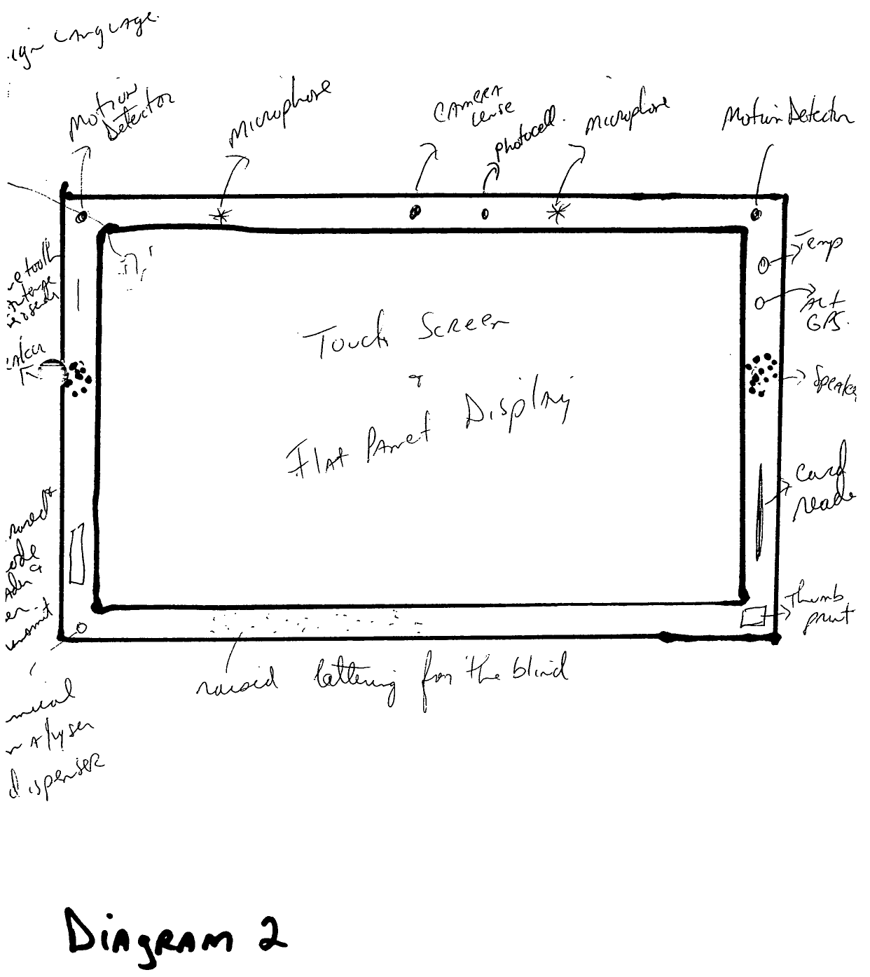

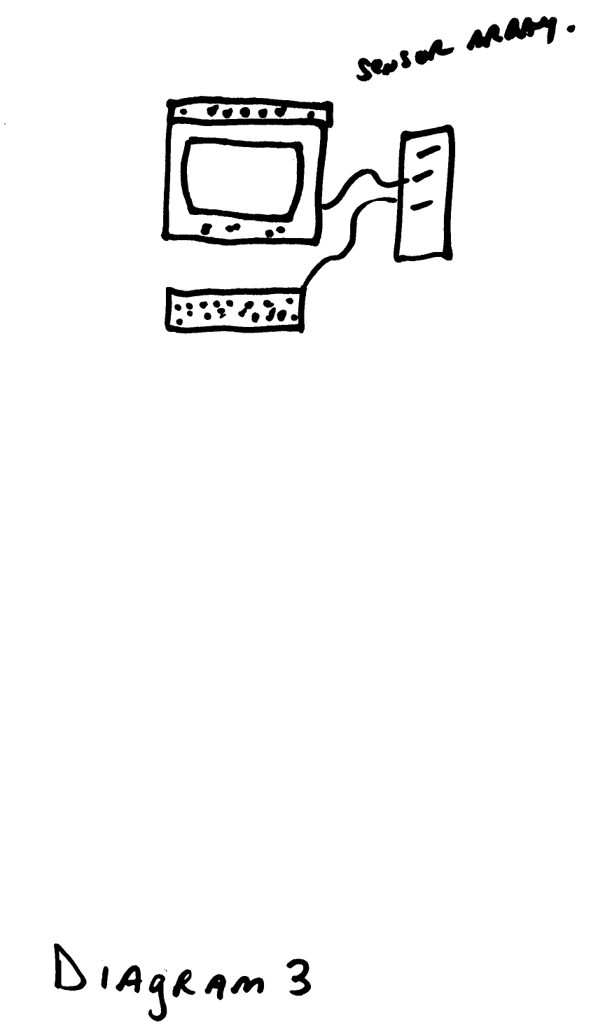

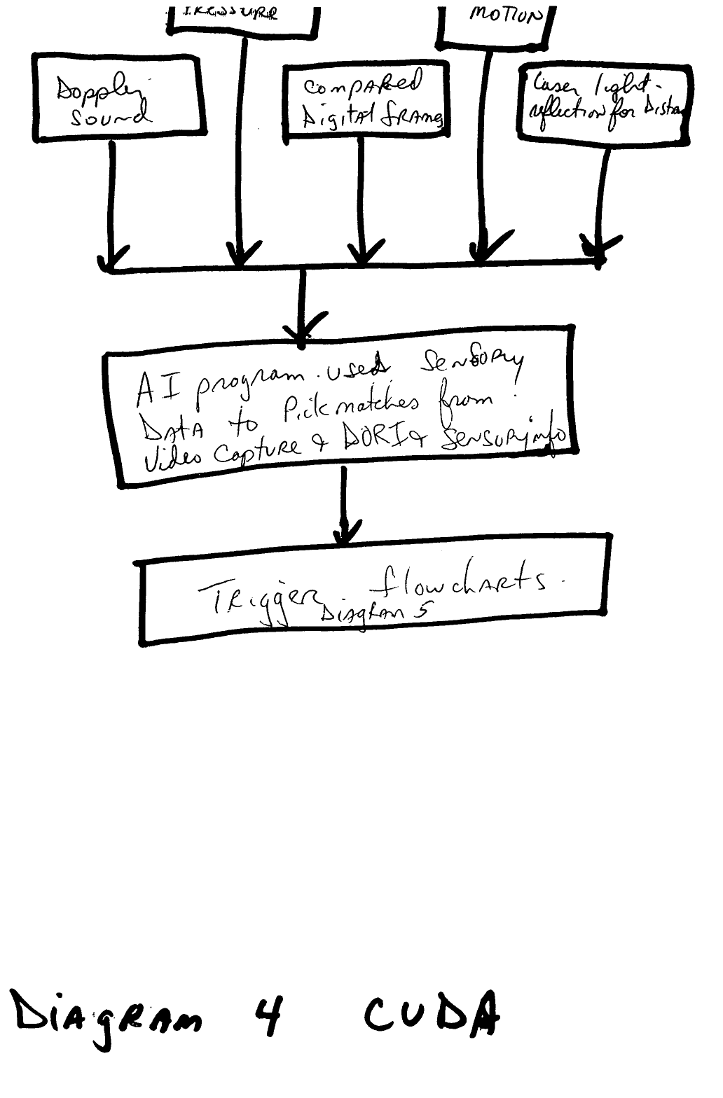

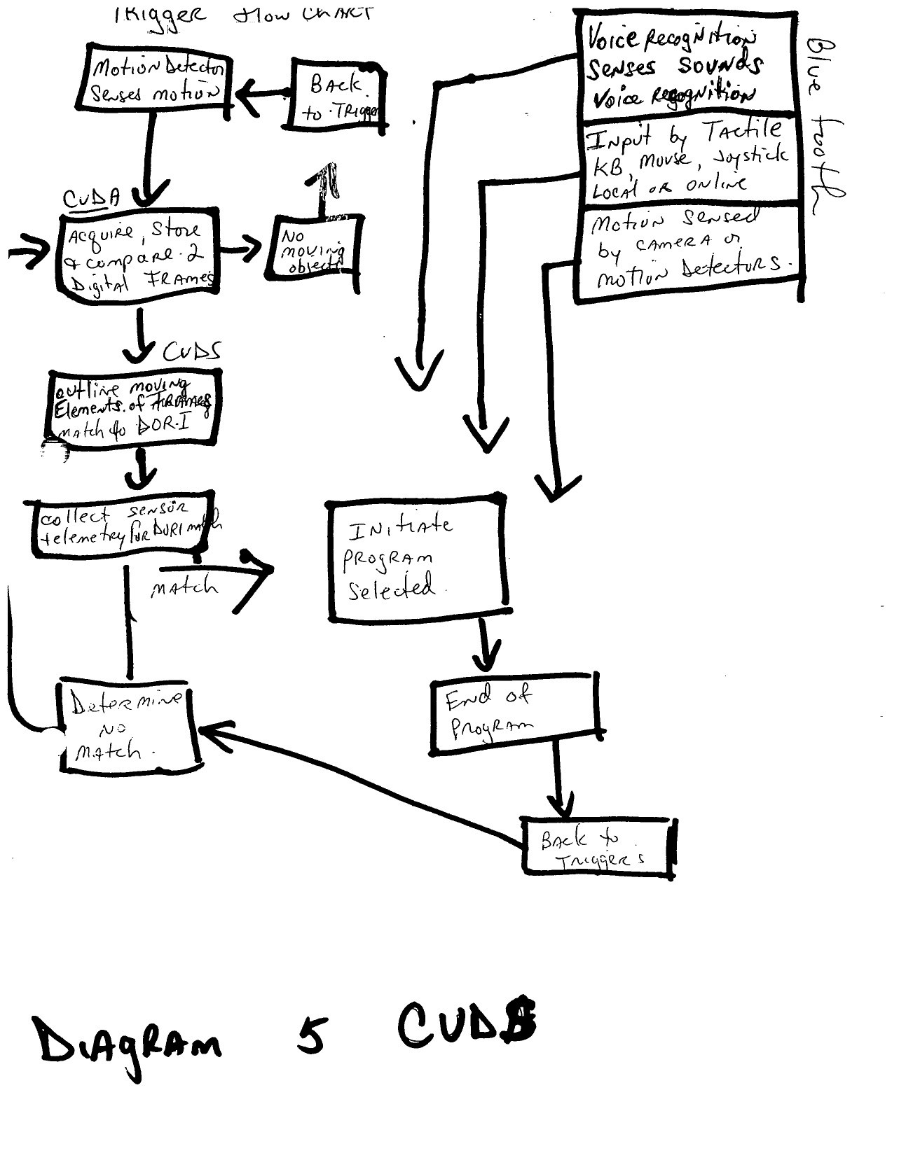

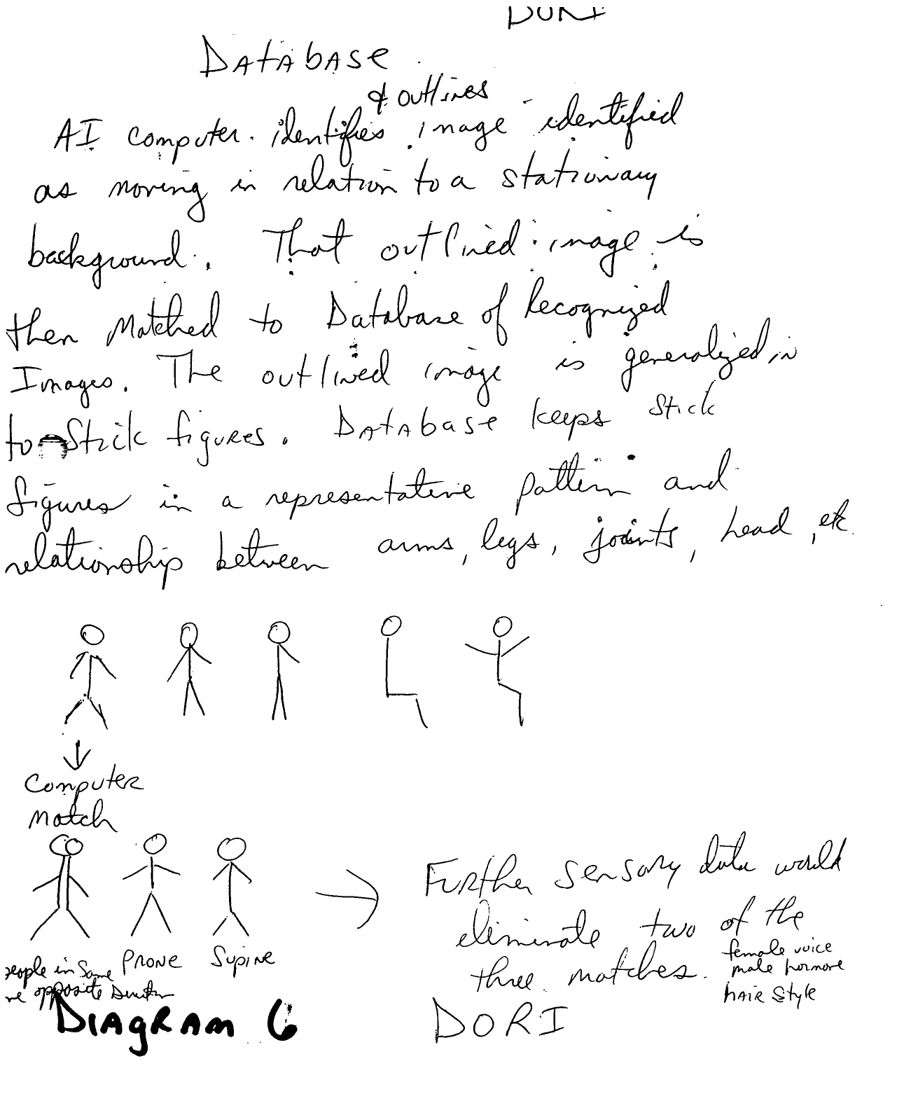

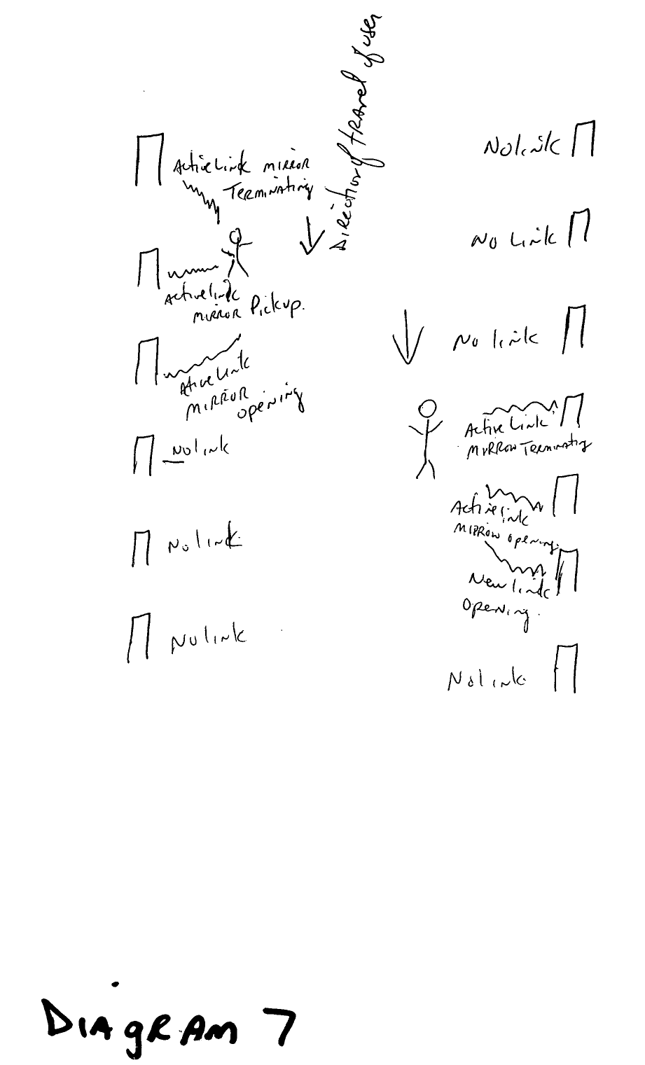

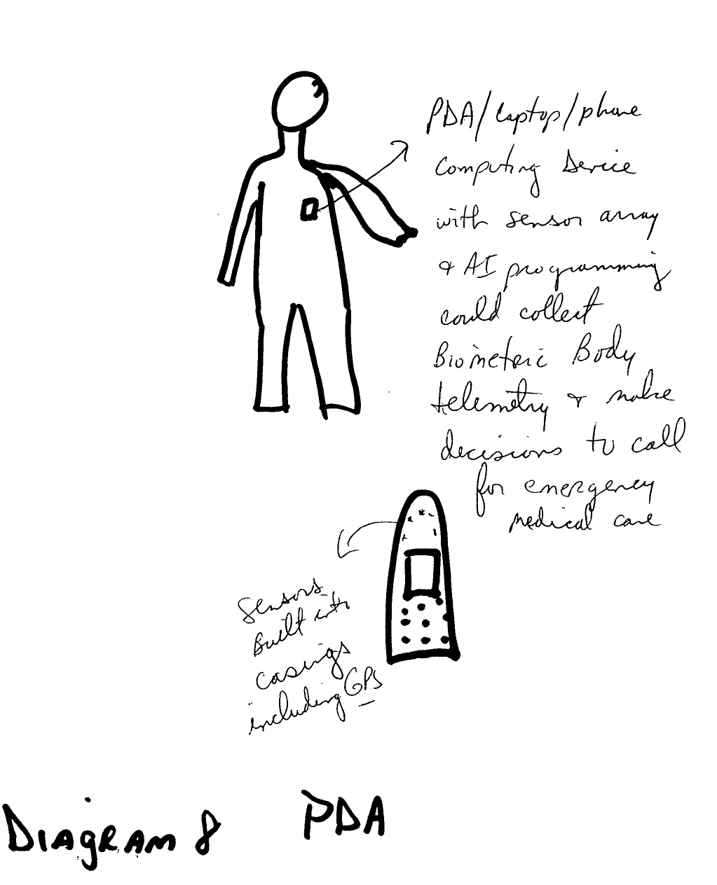

### CROSS-REFERENCE TO RELATED APPLICATIONS

### Related Applications

This application claims priority to U.S. Provisional Patent Application Nos. 53564002 filed Feb. 2, 2004, having the title “Connected Online Reactive Advertising Liteboard (CORAL)

### STATEMENT REGARDING FEDERALLY SPONSORED RESEARCH OR DEVELOPMENT

No federally sponsored or research or development funds were used.

### REFERENCE TO MICROFICHE APPENDIX

None

### BACKGROUND OF THE INVENTION

This is the Age of convergent Video and Broadband Network Topologies. The delivery of Advertising information is most useful when delivered to the right person at the right time by an automatically upgradeable software AI application generating targeted advertising based upon demographics, telemetry data from the sensor array and user interaction. Now with the sensitizied computer or sensitizied PDA or Coral Unit that advertising information delivery can be made without target interacting or making any initiating entry. The ads are delivered as POP UP windows with audio and sensory elements co-delivered reactively to presence of a target. The AI program classifies the target based upon stored elements matched to realtime sensory information. Delivery of the right information to the right person has been a problem that many businesses have attempted to solve over the years. Indeed an entire industry called advertising emerged. The digital Video and broadband convergence and higher processor speeds has changed the the delivery methodology available. The WWW and the TV have provided a way to deliver content rich information based on viewer choices. The ability to choose depends upon the target selecting a particular activity. CORAL is a novel independent advertising display device that chooses content based on telemetry received from the environment around it. The surrounding environment of PDA/Phone will allow for biometric monitoring of the human body. Now this novel patent seeks to deliver information based on computer analysis of it's surroundings and interpretations made about the existance and type of targets in it's immediate surroundings combined with a robust kiosk platform designed for the task and as a conduit to varied network topologies.

### SUMMARY OF THE INVENTION

Field of Invention

This invention relates to an apparatus system and method in which a sensor array generates telemetry which is manipulated by a AI application on a computer and matched to stored database records and produces a tailored advertising display for the target client passing in front of or near the CORAL Unit or/and provides a way to access more information or/and access other networks such as the PSTN (public switched telephone networks) and/or make emergency alerts to fire and ambulance for assistance.

Coral is a novel advertising delivery system based upon sensory data received by the sensor array of the Coral unit. That sensor unit can be configured in multiple configurations both stand alone and surface mounted like a picture frame and outdoors as a part of a free standing unit on sidewalks. The unit works in conjunction with Coral software and a computer which together exhibit the ability to react to telemetry and select and display advertising stored. The selection of ads is based upon the product of the algorithm based software. (a model match with a some degree of certainty)

The Coral unit may be described as “Advertising displays (flat panels) that have sensory telemetry processed from attached sensor array ((audio, video, radio,) multispectrum (UHF, VHF etc), motion, distance, Temperature, humidity, chemical analyser (hormone), gas (CO, O, CO2), microphone, pressure, altitude, GPS, IP connected and processed by a logaritlimatic computer program with AI capabilities) and will determine the most appropriate advertising to be displayed. Eg. (young short petite female walking past fast would be exposed to an Ad for pump shoes by short catchy audio video clip combined with a blue tooth ad signal, low power radio (am), or (young tall male approaching slowly would get a involved lenglity catchy ad for basketball sneakers by short catchy audio video clip combined with a blue tooth ad signal, low power radio (am)).”

Sensor array consists of motion detectors, digital video/infrared camera, photocell, microphone, speakers, chemical analyser, gas sensor (O, CO, CO 2), chemical dispenser (hormone, fragrances), infrared reciever, infrared transmitter, noise cancelation ability, light, raised lettering for blind, laser pointer, card reader strip and tumbprint sensor.

The Novel Coral Unit Decerner Application (CUDA) takes a series of fixed digital images or digital video image and first process the image to distinguish and outline the moving elements between frames versus the fixed background elements. The moving elements would further be process into form elements consistant with and matched to model element image files (ie. stick figure representations, fat, thin, tall, short, female voice etc.) stored in a storage device in a Novel Database Of Recognized Images (DORI). The DORI scores are rated on percent of match. DORI can be locally stored and updated by over the air (digital, video, Infrared, radio) or by a connected network (intranet, internet or proprietary network) to update advertising databases or transmit usage and billing information.

The Second Novel component is a Coral Unit Database Scheme (CUDS) that would establish matching variables for the Models (male, female, long hair, slim, fast walk, run, standing, bleeding, staggering, gesturing (sign language) etc.) and used to select ads to be displayed to target models. Advertisers would develop Ads according to set profiles aimed at appropriate end users. The Coral unit computer would display Ads by profiles based upon the sensor array data and the matching of target model elements.

The software application includes a display region used for POP UP advertising that is downloaded from the computer of from the internet. Ad selection is based upon the telemetry of the sensor array. The advertising displayed can vary based upon sensory perception of the local environment and matching models found by the AI programming. The pop ups can be one dominant full screen or multiple shared screen for a varied audience. Simultaneous Bluetooth transmissions of ads to individual PDA/Phone computing devices.

Therefore, existing systems do not provide an intergrated and readily available method for realtime sampling of the surrounding environment and displaying information and advertising content catered to that realtime sensory data recieved. Coral may decide by it's AI programming to contact 911 (older male supine immobile lowering body temperature). Coral can be miniturized for use in personal assitants or phones of any type. Can communicate by bluetooth or proprietary low frequency radio or infrared in addition to or instead of tactile, audio and microphone input.

Adding or incorporating a miniturized Coral sensory array to PDA/Phone computing device will allow the biometric monitoring of the human body for health monitoring and triggering emergency calls when the human body becomes incapacitated. The normal Coral, DORI and CUDS functionality will apply based on available connectivity.

Other patents are superceded by the novelty

U.S. Pat. No. 5,347,632 to Filepp et al. discloses a reception system in which both user demographics and individual system usage information can be used to target advertising. However, this information is used to select which advertisements are to be placed into an advertisement queue from which advertisements are then accessed, apparently in the order in which they were placed in the queue. Thus, this system permits targeting of advertising generally, but does not provide real time targeting of advertising based upon user actions.

U.S. Pat. No. 6,771,290 to Hoyle et al. discloses a method and apparatus for providing an automatically upgradeable software application alone, which includes targeted advertising based upon demographics and dependant on user interaction with the computer. These systems are dependant on user interaction to launch whereas the subject application of CORAL is launched by computer analysis of sensor array telemetry.

Internet users typically employ browser applications and related technologies in order to access the WWW; and to locate and view files, documents and audio/video clips. Exemplary browser applications include Opera by Opera Software, Netscape Navigator, Netscape Communicator 4.6 and Microsoft Internet Explorer 5.0., Mosaic, Browser applications are loaded onto a user's computer, and then can be used for communication over networks using protocols such as that utilized by the WWW. Browsers are useful for accessing desired files and web sites, and have the capability of storing information regarding visited or favorite web sites on the user's computer. However, it has been common practice for browsers to be employed by the user for fairly limited purposes, such as accessing information. Certain applications, such as Windows XP, Windows NT 4.0, LINUX, allow a user to receive and store electronic information on a limited network system. However, the usefulness and flexibility of such systems are severely limited, because each browser installation traditionally has been independent of other browser installations to which a user has access. Thus, information within one browser is not easily transportable to the other browser.

The Coral unit additionally acts as an interface or connection between computing devices and the world of broadband connected and on air networks. Delivering targeted advertising and acting as an interface to networks like the PSTN.

Definitions

Except as may be explicity indicated otherwise, the following definitions shall apply:

browser—A program that can communicate over a network using http or another protocol and that can display html information and other digital information.

client computer—A computer that is connected to a network (including computers that are connected only occasionally to the network such as, for example, by a modem and telephone line) and that can be used to send requests for information to other computers over the network.

computer—An apparatus having a processing device that is capable of executing instructions, including devices such as personal computers, laptop computers, and personal digital assistants, as well as set top television boxes, televisions, radios, portable telephones, and other such devices having a processing capability.

computer usage information—Data concerning a person's use of a computer, including such things as what programs they run, what information resources they access, what time of day or days of the week they use the computer, and so forth.

data set—A group of data items; for example, links, keywords, or entries in an address book.

display object—Data capable of display by a computer, including graphical images as well as multimedia presentations or other display data that includes audio in addition to visually-perceived data.

file—Any digital item, including information, documents, applications, audio/video components, and the like, that is stored in memory and is accessible via a file allocation table or other pointing or indexing structure.

graphical image—Visually-perceived data stored in a graphic format (e.g., jpeg, gif, bmp, tiff, pcx, etc.), including electronically-reproduced photographs, graphics, animations, icons, and textual messages.

information resource—A source of information stored on a server or other computer that is accessible to other computers over a network.

keyword—A textual data item used in locating related sources of information

link—A data item that identifies the location or address of a program or information resource. A URL is a link, as is a path and filename of an information resource.

network—A system having at least two computers in communicable connection, including intranets, personal networks, virtual private networks, and global public networks such as the Internet.

non-volatile data storage device—A memory device that retains computer-readable data or programming code in the absence of externally-supplied power, including such things as a hard disk or a floppy disk, a compact disk read-only memory (CDROM), digital versatile disk DVD), magneto-optical disk, and so forth.

profile—User-specific information relating to an individual using a computer.

program component—A set of instructions stored in a file in computer-readable format, whether as object code or source code, and whether written in a compiled language, in byte code (such as Java.™), or in a scripting or other interpreted language.

program module—One or more related program components.

program—One or more related program modules.

reactively—In response to some type of user input, such as a mouse click on a particular user application or on a link to an information resource

server—A computer on a network that stores information and that answers requests for information.

software application—A program and associated libraries and other files; for example, a word processing application, a spreadsheet application, or a personal information management application.

Additional Aspects of the Invention

CORAL unit allows for connection to the Internet, PSTN, VNAP/like word recognition software, Video on Demand or stand alone computing requirements.

Miniturized sensor array can be used to measure and record biometric sensory data to determine the health of the user or to summon help should the tlemetry indicate incapacity in an emergency situation. Low oxygen, low/high blood pressure, low/high temperature, low or high pulse conditions that could point to emergency situations requiring emergency medical care. The unit being GPS capable can make emergency calls and notify authorities on percieved health emergencies.

The Target may choose to interact with panel by voice, sign (gesture), touch, typing, mouse, joystick (interface device) or bluetooth input or output to get a response and additional information.

### BRIEF DESCRIPTION OF THE SEVERAL VIEWS OF THE DRAWINGS

Diagram 1: CORAL Kiosk Model: contains all the hardware components in a rugged outdoor/indoor standalone format. These model will vary by how rugged the design is. The difference will be in composition of the external components steel vs composite stone or plastics or polycarbonate or plexiglass or combinations thereof. The basic components of the sensory array frame the video display. The input devices also frame the display. The computer and storage devices and peripherals and tranmission equipment below, within and behind the body of the unit along with a power supply, backup and communication connections devices. Units can be dual sided or more depending on configuration required.

Diagram 2:CORAL Kiosk Frame Model:

contains all the hardware components in a rugged outdoor/indoor Frame format. These model will vary by how rugged the design is. The difference will be in composition of the external components steel vs polycarbonate or plexiglass. The basic components of the sensory array frame the video display. The input devices also frame the display. The computer and storage devices and peripherals and tranmission equipment within and behind the body of the unit along with a power supply, backup and communication connections devices. Units can be dual sided or more depending on configuration required.

Diagram 3: CORAL computer unit:

The sensory array is packaged to be an add-on to computer systems or intergrated into PDA or Displays.The basic components of the sensory array frame the video display. The input devices also frame the display. The computer and storage devices and peripherals and tranmission equipment within and behind the body of the unit along with a power supply, backup and communication connections devices.

Diagram 4: Block diagram of CUDA: Is a method and process of combining and comparing video, dual source motion detectors, laser light transmitter and receiver for distance, audio and microphone for distance and sound pitch and sound base, pressure sensors for vibrations, chemical analysers for hormone and key chemical (co, co2, h20, hc, o)

Diagram 5: Block diagram of CUDS:

establish matching variabled for the Models (male, female, long hair, slim, fast walk, run, standing, bleeding, staggering, gesturing(sign language) etc.) and select ads to be displayed to target models. Advertisers would develop Ads according to set profiles for aimed at appropriate end users. The Coral unit computer would display Ads by profiles based upon the sensor array data and the matching target model elements.

Diagram 6: DORI:

into form elements consistant with and matched to model element image files (ie. stick figure representations, fat, thin, tall, short, female voice etc.) stored in a storage device in a Novel Database Of Recognized Images (DORI). The DORI scores are rated on percent of match. DORI can be locally stored and undated by over the air (digital, video, Infrared, radio) or connected by network (intranet, internet or proprietary network) to update advertising databases or transmit usage information.

Diagram 7: Kiosk relay and mapping:

A series of closely positioned CORAL Kiosks are engaged in mirroring of a link to data somewhere on the connected networks for the use and access of a mobile computing user device with predictive transfer of the link in the direction of travel by the computing user device.

Diagram 8: PDA/laptop/phone add-on or intergration:

Pda/laptop/phone computing device with an intergrated miniturized sensor array carried on the person with direct or near direct contact to the user body. A low fequency or bluetooth connection to a PDA/laptop/phone for access to network elements or monitoring of biometric information for health diagnosis, medical emergencies reasons or to transmit advertising to the end user computing device.

### DETAILED DESCRIPTION OF THE INVENTION

In the following description, numerous specific details are set forth such as specific components to provide a thorough understanding of the present invention. Those details can vary depending on the computer system and display chosen. However, it will be obvious to those of ordinary skill in the art that the present invention can be practiced without specific set of computer components. Substitution of flat panel vs CRT or PC based or Alpha based computer. The essential elements being the combined in a sensor array. That array sending telemetry to the computer which then processes the information by AI to select and display advertising. The advertising is initially two tiered based (demographic by location of CORAL and by Sensory data match) then becomes multitiered when the target provides input by jesture or other means. Coral based upon independently acquired information of the environment makes matched to a defined database resulting in a selected advertising to be displayed or action being performed. With the additional functionality of access to all forms of convergent Video/Broadband two way data transfers and a way to charge and collect for those usages.

Manufacturing Process for:

The Coral standalone unit uses the edge of the video display for the point of framing. The video lense is centered on the unit top frame. The motion detector is placed along the top frame, the bar code reader and infrared laser, speaker along the left frame side, the card reader slot microphone, speaker on right frame side, chemical sensor and chemical emitter on bottom frame, along with thumb print and blind raised letter. Depending on the location and availablity of the CORAL standalone unit a backup battery power supply is located in the base of the unit. Those batteries can be attached to a solar collectors for an independent power generation capability. The computer, storage device and interface are located below and behind the display.

What is claimed is:

1. The concept, process, apparatus, design, methods, systems, utility and intergration of a computer process based, self reliant and self acquisitioning computer intellegence relying on local environmental telemetry from a sensor array. The Telemetry used by the AI programming for the purpose of selecting relevant information for the purpose of acquiring targeted informational advertising, determining (911 calls fire and ambulance) dangerous situations (health emergency, fire emergency) and responding. Reacting to inputs requesting access to additional information and/or communications via video/Broadband data connections by light and/or radio frequencies and/or charged wired networks with or without user intervention or direction.

2. A computer-readable memory for use by a client computing device and/or client computer and/or in conjunction with a client server, to provide a user of the computing device with an intergrated, customized, graphical user interface to a plurality of network connections, with access to content rich computer resources, information, advertising, in the computer-readable memory comprising:
a non-volatile data storage device; a program stored on said non-volatile data storage device in a computer-readable format;
said program utilizing telemetry from the local sensor array being operable upon trigger of the array to display a graphical user interface comprising an application window seperated into a number of region, the first one of said regions including a number of graphical objects, at least some of which represent different software applications and are selectible by the user via an input device. The program already displaying the advertisement allows the user to respond by selection of one of the said graphical objects to initiate execution of additional software applications therewith;
a second one of said regions including a number of user-selectable items, at least some of which are each associated with a different data set, said data sets each comprising a number of links to different information resources, wherein said program is operable in response to selection of at least one of said items to provide the user with access to its associated data set;
said program including a login module that is operable upon execution to identify the user of the computer;
and said program being operable following execution of said login module to provide an identification of the user to the server and to receive from the server a user profile containing one or more user data sets and user links to information resources, with said program further being operable to display in one of said regions a user-selectable item for each of said user data sets and each of said user links.

3. A system and apparatus and method in which sensor telemetry initiates, by AI processing, access to multiple Video and broadband network access providers cooperative to enable output of video, audio, voicepages, data and combinations thereof in mono and bidirectional transmissions to the end user.

4. A method and apparatus and process to accept sensor telemetry and use AI programming to produce a model of the moving elements of the immediate environment. Then match those elements to stored profiles of elements which are then cross matched to a target model profile that points to targeted information and/or advertising which is displayed in response to the telemetry.

5. A method and apparatus and process of passing active links for a mobile user based upon proprietary and public handshake protocols. A mobile computing device can be actively connected via an active link to a datastream established between a set of CORAL devices and single mobile computing device. The active links changing Coral Kiosk base units based on direction of travel and strenght of signal.

6. The concept, process, apparatus, design, methods, systems, utility and intergration of a computer process based self reliant and self acquisitioning computer intellegence relying on local environmental telemetry from a sensor array for the purpose of monitoring the biometrics of the heartbeat, blood pressure, oxygen sat, temperature of the user selecting relevant model elements for the purpose of targeted advertising, determining with reaction (911 calls fire and ambulance) dangerous situations (health emergency, fire emergency) and responding to inputs requesting access to additional information and/or communications via video/Broadband data connections by light and/or radio frequencies and/or charged wired networks.

7. The concept, process, apparatus, design, methods, systems, utility and intergration of a computer process based PDA/Phone/laptop/tablet/phone/pen computing device to a minuturized sensor array with self reliant and self acquisitioning computer intellegence programming. The computing device relying on local environmental telemetry from a sensor array to monitor the biometric telemetry of a human body, namely the user, for the purpose of selecting relevant model elements for the purpose of targeted advertising, determining (911 calls fire and ambulance) dangerous situations (health emergency, low oxygen, low blood pressure, low or high pulse, fire emergency) and responding to inputs requesting access to additional information and/or communications via video/Broadband data connections by light and/or radio frequencies and/or charged wired networks to retrieve information or call for medical emergencies.

8. The concept, process, apparatus, design, methods, systems, utility and intergration of a computer process based Kiosk based computing device connected to a sensor array with self reliant and self acquisitioning computer intellegence programming. The computing device relying on local environmental telemetry from a sensor array to monitor the local environment selecting relevant model elements for the purpose of targeted advertising, determining (911 calls fire and ambulance) dangerous situations (health emergency, low oxygen, low blood pressure, low or high pulse, fire emergency) and responding to inputs requesting access to additional information and/or communications via video/Broadband data connections by light and/or radio frequencies and/or charged wired networks to retrieve information or call for medical emergencies.

9. The concept, process, apparatus, design, methods, systems, utility and intergration of a computer process based trigger feedback system on a computing device with a sensor array with self reliant and self acquisitioning computer intellegence programming. The computing device relying on local environmental telemetry from a sensor array to monitor local environment and responding to movement and inputs requesting access to additional information and/or communications via video/Broadband data connections by light and/or radio frequencies and/or charged wired networks to retrieve information or call for medical emergencies.

10. The concept, process, apparatus, design, methods, systems, utility and intergration of a computer process based of displaying information in a single or multiple pop up graphical windows on a display screen for the viewing of Ai programming perceived clients in the immediate vicinity of the Sensory array field of sense.

11. The concept, process, apparatus, design, methods, systems, utility and intergration of a computer process based by which telemetry from a sensory array can be utilized to match stored model sensory data and cross matched to stylized model client profiles and further matched to appropriate display of information based on stored stylized profiles. The stored stylized profiles are set with a set of generalized attributes not sensed by the sensory array but are associated by real world experiences and practice.

12. The concept, process, apparatus, design, methods, systems, utility and intergration of a computer process based by which sequential digital images are compared to expose the moving elements and those moving elements are outlined and further converted to stylized stick figures depicting different angles of perspective on subject (ie. Human) prone, supine, standing, sitting, front, side, tall, short, and matched to stored stylized models and associated attributes.

13. The concept, process, apparatus, design, methods, systems, utility and intergration of a computer process based by which AI programing checks for reliability of the matching or sensory data to stored stylized data. That stylized data converted to a definite match witn degree of accuracy.

14. A computer program product with AI input comprising: a computer readable usable medium having computer readable program code means embodied in the medium for navigating an image contained in a window, the computer readable program code means including
means for creating a navigational area superimposed on the image and having a shape and color so as to provide minimal interference with the image;
means for inserting a location indicator into the navigational area;
means for dragging the location indicator from an initial position to a final position;
means for indicating, prior to moving the image, the distance from the initial position to the final position; and
means for moving the image, within the confines of the window, in a direction and distance corresponding to the initial and final positions of the location indicator.
means for repositioning, after the image has moved, the location indicator back to the initial position.
navigational area has a one-to-one correspondence with the window. the computer readable program code means further includes:
means for dropping the location indicator on the final position.
the means for moving the image includes:
means for moving the image, within the confines of the window and in response to the dropping of the location indicator, in a direction and distance corresponding to the initial and final positions of the location indicator.

15. The concept, process, apparatus, design, methods, systems, utility and intergration of a computer process based accounting and capture of billing information of user usage based on time of day, quantity of data usage, user info, destination info, length of usage, and other industry standard records.

16. The concept, process, apparatus, design, methods, systems, utility and intergration of a computer, display screen, tactile input devices, non-tactile input devices (voice, sign language, gestures, chemical etc) with sensor array for identification, usage billing and interaction with the user, content providers and the Kiosk.

17. The concept, process, apparatus, design, methods, systems, utility and intergration of a computer process based on real world data, real time data and mono and bidirectional communications with a user. Yielding an uninitiated communication profile from which further actions can be taken by the AI program or the user. (user can be provided bus timetable, actual location of bus on the way to the bus stop).

18. The concept, process, apparatus, design, methods, systems, utility and intergration of a computer process based on real world data, real time data and mono and bidirectional communications with a user body. Yielding a medical profile from which actions could be taken by the AI program or the users doctors. (user can be alerted to low oxygen level while walking uphill).
